(19) United States
(12) Patent Application Publication
(10) Pub. No.: US 2019/0278387 A1
(43) Pub. Date: Sep. 12, 2019

(54) System and Method of Utilizing an Activation Force with a Stylus

(71) Applicant: Dell Products L.P., Round Rock, TX (US)

(72) Inventors: Thomas P. Lanzoni, Cedar Park, TX (US); Asim M. Siddiqui, Cedar Park, TX (US)

(21) Appl. No.: 15/914,642

(22) Filed: Mar. 7, 2018

(51) Int. Cl. G06F 3/0354; G06F 3/041; G06F 3/0488; G06F 3/0481

(52) U.S. Cl. CPC G06F 3/03545; G06F 3/04817; G06F 3/0488; G06F 3/0414

(57) ABSTRACT

In one or more embodiments, one or more systems, methods, and/or processes may configure at least one of a stylus and a touch controller to utilize the first mode; may receive first user input associated with the stylus in contact with a surface and associated with a measurement of a force of the stylus with the surface; may determine a first number of pixels to activate based at least on the measurement of the force and the first mode; may configure the at least one of the stylus and the touch controller to utilize the second mode; may receive second user input associated with the stylus in contact with the surface and associated with the measurement of the force of the stylus with the surface; and may determine a second number of pixels to activate based at least on the measurement of the force and the second mode.

### BACKGROUND

### Field of the Disclosure

This disclosure relates generally to information handling systems and more particularly to utilizing a stylus with an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

In one or more embodiments, one or more systems, methods, and/or processes may receive first information that indicates a first mode of multiple modes of utilizing a stylus that are associated with multiple response curves; may configure a touch controller to utilize the first mode that is associated with a first activation force; may receive first user input associated with the stylus in contact with a surface and associated with a measurement of a force of the stylus with the surface; may determine that the measurement of the force of the stylus with the surface meets the first activation force; may adjust first output from the stylus to comply with a first response curve, of the multiple response curves, associated with the first mode; may determine a first number of pixels to activate based at least on the measurement of the force of the stylus with the surface and an adjustment of the first output from the stylus to comply with the first response curve; may activate first pixels associated with the first number of pixels; may receive second information that indicates a second mode of the multiple modes of utilizing the stylus; may configure the touch controller to utilize the second mode that includes a second activation force; may receive second user input associated with the stylus in contact with the surface and associated with the measurement of the force of the stylus with the surface; may determine that the measurement of the force of the stylus with the surface meets the second activation force; may adjust second output from the stylus to comply with a second response curve, of the multiple response curves, associated with the second mode; may determine a second number of pixels, different from the first number of pixels, to activate based at least on the measurement of the force of the stylus with the surface and an adjustment of the second output from the stylus to comply with the second response curve; and may activate second pixels associated with the second number of pixels.

In one or more embodiments, adjusting the first output from the stylus to comply with the first response curve may include adjusting the first output from the stylus by a constant. In one or more embodiments, receiving the first user input associated with the stylus in contact with the surface and associated with the measurement of the force of the stylus with the surface may include determining the measurement of the force of the stylus with the surface. For example, determining the measurement of the force of the stylus with the surface may include wirelessly receiving the measurement of the force of the stylus with the surface. In one or more embodiments, activating the first pixels associated with the first number of pixels may include activate the first pixels, on a display, associated with the first number of pixels, and activating the second pixels associated with the second number of pixels may include activating the second pixels, on the display, associated with the second number of pixels. In one or more embodiments, receiving the first information that indicates the first mode of the multiple modes of utilizing the stylus may include receiving the first information via at least one of an application, the stylus, and a setup utility of an operating system. In one or more embodiments, receiving the first information that indicates the first mode of the multiple modes of utilizing the stylus may include receiving the first information via a user interface. For example, the user interface may be or include a graphical user interface.

In one or more embodiments, a stylus may receive first information that indicates a first mode of multiple modes of utilizing the stylus that are associated with multiple response curves; may configure the stylus to utilize the first mode that is associated with a first activation force; may receive first user input associated with the stylus in contact with the surface and associated with a measurement of a force of the stylus with the surface; may determine that the measurement of the force of the stylus with the surface meets the first activation force; may adjust first output from the force sensor to comply with a first response curve, of the multiple response curves, associated with the first mode; may provide, to an information handling system, an adjustment of the first output from the force sensor that complies with the first response curve; may receive second information that indicates a second mode of the multiple modes of utilizing the stylus; may configure the stylus to utilize the second mode that includes a second activation force; may receive second user input associated with the stylus in contact with the surface and associated with the measurement of the force of the stylus with the surface; may determine that the measurement of the force of the stylus with the surface meets the second activation force; may adjust second output from the stylus to comply with a second response curve, of the multiple response curves, associated with the second mode; and may provide, to the information handling system, an adjustment of the second output from the force sensor that complies with the second response curve.

In one or more embodiments, adjusting the first output from the force sensor to comply with the first response curve may include adjusting the first output from the force sensor by a constant. In one or more embodiments, providing the adjustment of the first output from the force sensor that complies with the first response curve may include wirelessly providing, to the information handling system via a communication device, the adjustment of the first output from the force sensor that complies with the first response curve. In one or more embodiments, receiving the first information that indicates the first mode may include wirelessly receiving, via the communication device, the first information that indicates the first mode from at least one of an application, a graphical user interface, and a setup utility of an operating system that executes on the information handling system. In one or more embodiments, receiving the first user input associated with the stylus in contact with the surface and associated with the measurement of the force of the stylus with the surface may include determining the measurement of the force of the stylus with the surface via a force sensor. For example, determining the measurement of the force of the stylus with the surface via the force sensor may include receiving the digital data from the analog to digital converter. For instance, the digital data may include numerical values that represent respective measurements of forces of the stylus with the surface.

### BRIEF DESCRIPTION OF THE DRAWINGS

For a more complete understanding of the present disclosure and its features/advantages, reference is now made to the following description, taken in conjunction with the accompanying drawings, which are not drawn to scale, and in which:

FIG. 1A illustrates an example of an information handling system, according to one or more embodiments;

FIGS. 1B and 1C illustrate examples of displays and an example of an information handling system, according to one or more embodiments;

FIGS. 2A and 2B illustrate an example stylus, according to one or more embodiments;

FIG. 3A illustrates examples of response curves, according to one or more embodiments;

FIGS. 3B-3D illustrate an examples of adjusting a response curve to another response curve, according to one or more embodiments;

FIG. 4 illustrates an example graphical user interface, according to one or more embodiments;

FIG. 5 illustrates examples of digital markings, according to one or more embodiments;

FIG. 6 illustrates other examples of digital markings, according to one or more embodiments;

FIGS. 7A and 7B illustrate an example of a method of utilizing an information handling system, according to one or more embodiments; and

FIGS. 8A and 8B illustrate an example of a method of operating a stylus, according to one or more embodiments.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter following such reference numeral refers to a specific instance of a particular entity of that class or type. Thus, for example, a hypothetical entity referenced by ‘12A’ may refer to a particular instance of a particular class/type, and the reference ‘12’ may refer to a collection of instances belonging to that particular class/type or any one instance of that class/type in general.

In one or more embodiments, a stylus may have an activation force in a range (e.g., 0.147-0.196 Newtons (or 15-20 grams)) before a display begins to change pixels in response to the stylus. For example, the activation force of 0.147-0.196 Newtons may align or map to devices such as pens or pencils. For instance, markups, pointing, and/or note taking applications may perform well with the activation force of 0.147-0.196 Newtons. In one or more embodiments, other devices, such as paintbrushes, felt pens, charcoals, crayons, and calligraphy pens, among others, may utilize other activation forces. For example, in simulating the other devices, a stylus may utilize activation forces below 0.147 Newtons. For instance, a stylus that simulates a pen for artist may utilize an activation force around 0.0098 Newtons in providing a good user experience.

In one or more embodiments, a stylus may be utilized with a range of activation forces. For example, a user may configure one or more ranges of activation forces for one or more applications. In one instance, the user may configure an activation force for markups, pointing, and/or note taking applications. In another instance, the user may configure one or more activation forces for one or more paint brushes, one or more felt pens, one or more charcoals, one or more crayons, and/or one or more calligraphy pens, among others. In one or more embodiments, a stylus may be capable of one or more low activation forces and may be associated with a response curve that can be shaped to simulate that of a higher activation force. For example, a single stylus can be configured and/or customized to satisfy a range of uses and/or users (e.g. artists, note takers, etc.). In one instance, the stylus may be configured with an activation force of 0.049 Newtons (e.g., 5 g), which may be utilized in an artistic context. In another instance, the stylus may be configured with an activation force of 0.196 Newtons (e.g., 20 g), which may be utilized in a note-taking context.

In one or more embodiments, a stylus may be configured to modify and/or alter one or more pressure responses before providing data to a touch controller. For example, modifying and/or altering the one or more pressure responses may shift and/or clamp an intrinsic pressure response curve and generate a new response curve. In one or more embodiments, a touch controller may be configured to modify and/or alter one or more pressure responses before providing data to an operating system. For example, the touch controller may receive intrinsic response data from a stylus and apply one or more corrections before providing stylus data to an operating system.

In one or more embodiments, a graphical user interface may be utilized in configuring one or more of a stylus and a touch controller, among others. For example, the graphical user interface may receive user input that indicates one or more configurations of one or more activation forces to be utilized with the stylus. In one instance, a graphical user interface of an application may be utilized in configuring the one or more of the stylus and the touch controller. In another instance, a graphical user interface of an operating system may be utilized in configuring the one or more of the stylus and the touch controller. In one or more embodiments, an application may configure one or more activation forces based at least on one or more contexts. In one example, the application may configure one or more activation forces based at least on a context of the application is an artistic application. For instance, the application may be or include a paintbrush tool. In another example, the application may configure one or more activation forces based at least on a context of a tool selection. In one instance, a pen tool may be selected, and the application may configure one or more activation forces based at least on a context of the pen. In another instance, a paintbrush tool may be selected, and the application may configure one or more activation forces based at least on a context of the paintbrush.

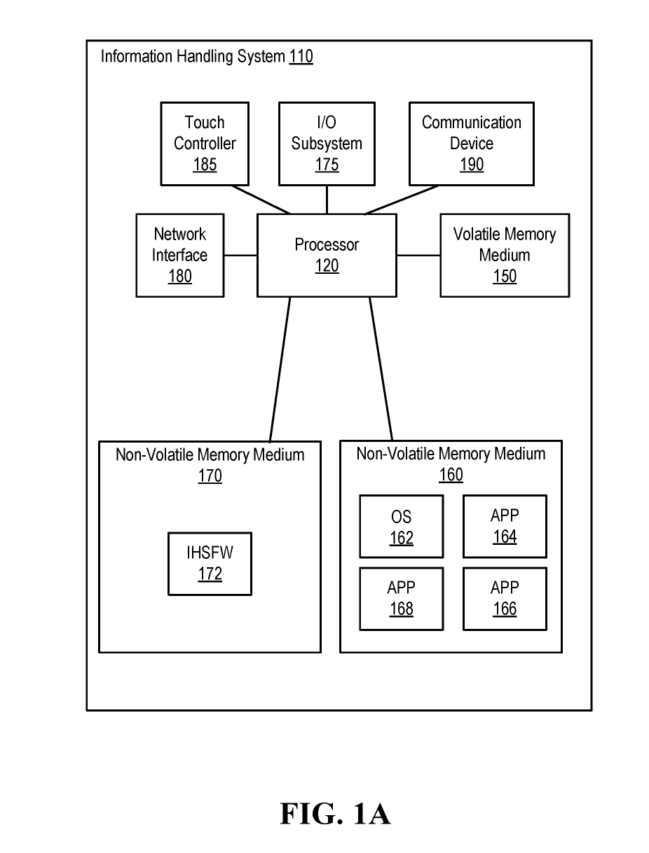

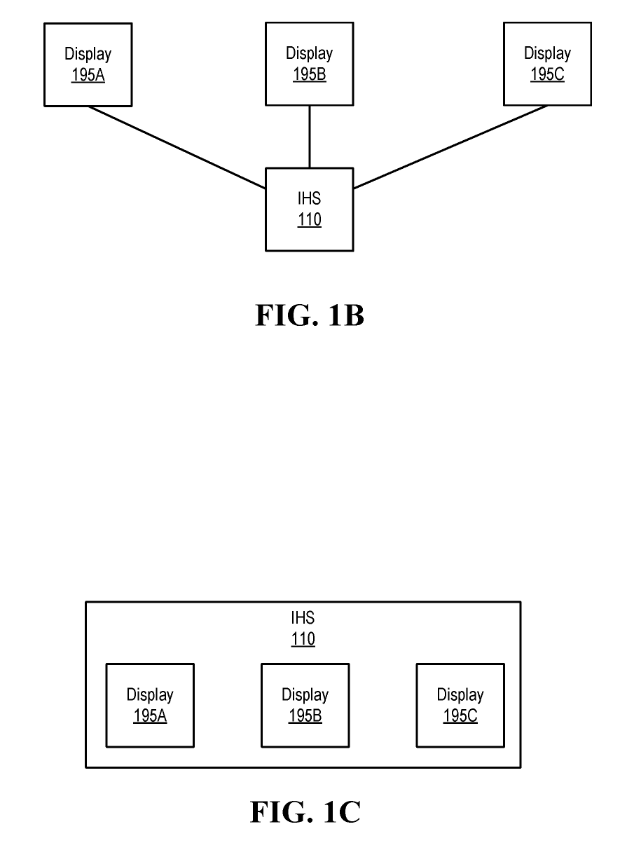

Turning now to FIG. 1A, an example information handling system is illustrated, according to one or more embodiments. An information handling system (IHS) 110 may include a hardware resource or an aggregate of hardware resources operable to compute, classify, process, transmit, receive, retrieve, originate, switch, store, display, manifest, detect, record, reproduce, handle, and/or utilize various forms of information, intelligence, or data for business, scientific, control, entertainment, or other purposes, according to one or more embodiments. For example, IHS 110 may be a personal computer, a desktop computer system, a laptop computer system, a server computer system, a mobile device, a tablet computing device, a personal digital assistant (PDA), a consumer electronic device, an electronic music player, an electronic camera, an electronic video player, a wireless access point, a network storage device, or another suitable device and may vary in size, shape, performance, functionality, and price. In one or more embodiments, components of IHS 110 may include one or more storage devices, one or more communications ports for communicating with external devices as well as various input and output (I/O) devices, such as a keyboard, a mouse, and a video display, among others. In one or more embodiments, IHS 110 may include one or more buses operable to transmit communication between or among two or more hardware components. In one example, a bus of IHS 110 may include one or more of a memory bus, a peripheral bus, and a local bus, among others. In another example, a bus of IHS 110 may include one or more of a Micro Channel Architecture (MCA) bus, an Industry Standard Architecture (ISA) bus, an Enhanced ISA (EISA) bus, a Peripheral Component Interconnect (PCI) bus, HyperTransport (HT) bus, an inter-integrated circuit (I²C) bus, a serial peripheral interface (SPI) bus, a low pin count (LPC) bus, an enhanced serial peripheral interface (eSPI) bus, a universal serial bus (USB), a system management bus (SMBus), and a Video Electronics Standards Association (VESA) local bus, among others.

In one or more embodiments, IHS 110 may include firmware that controls and/or communicates with one or more hard drives, network circuitry, one or more memory devices, one or more I/O devices, and/or one or more other peripheral devices. For example, firmware may include software embedded in an IHS component utilized to perform tasks. In one or more embodiments, firmware may be stored in non-volatile memory, such as storage that does not lose stored data upon loss of power. In one example, firmware associated with an IHS component may be stored in non-volatile memory that is accessible to one or more IHS components. In another example, firmware associated with an IHS component may be stored in non-volatile memory that may be dedicated to and includes part of that component. For instance, an embedded controller may include firmware that may be stored via non-volatile memory that may be dedicated to and includes part of the embedded controller.

As shown, IHS 110 may include a processor 120, a volatile memory medium 150, non-volatile memory media 160 and 170, an I/O subsystem 175, a network interface 180, a touch controller 185, and a communication device 190. As illustrated, volatile memory medium 150, non-volatile memory media 160 and 170, I/O subsystem 175, network interface 180, touch controller 185, and communication device 190 may be communicatively coupled to processor 120.

In one or more embodiments, one or more of volatile memory medium 150, non-volatile memory media 160 and 170, I/O subsystem 175, and network interface 180 may be communicatively coupled to processor 120 via one or more buses, one or more switches, and/or one or more root complexes, among others. In one example, one or more of volatile memory medium 150, non-volatile memory media 160 and 170, I/O subsystem 175, and network interface 180 may be communicatively coupled to processor 120 via one or more PCI-Express (PCIe) root complexes. In another example, one or more of an I/O subsystem 175 and a network interface 180 may be communicatively coupled to processor 120 via one or more PCIe switches.

In one or more embodiments, the term “memory medium” may mean a “storage device”, a “memory”, a “memory device”, a “tangible computer readable storage medium”, and/or a “computer-readable medium”. For example, computer-readable media may include, without limitation, storage media such as a direct access storage device (e.g., a hard disk drive, a floppy disk, etc.), a sequential access storage device (e.g., a tape disk drive), a compact disk (CD), a CD-ROM, a digital versatile disc (DVD), a random access memory (RAM), a read-only memory (ROM), a one-time programmable (OTP) memory, an electrically erasable programmable read-only memory (EEPROM), and/or a flash memory, a solid state drive (SSD), or any combination of the foregoing, among others.

In one or more embodiments, one or more protocols may be utilized in transferring data to and/or from a memory medium. For example, the one or more protocols may include one or more of small computer system interface (SCSI), Serial Attached SCSI (SAS) or another transport that operates with the SCSI protocol, advanced technology attachment (ATA), serial ATA (SATA), a USB interface, an Institute of Electrical and Electronics Engineers (IEEE) 1394 interface, a Thunderbolt interface, an advanced technology attachment packet interface (ATAPI), serial storage architecture (SSA), integrated drive electronics (IDE), or any combination thereof, among others.

Volatile memory medium 150 may include volatile storage such as, for example, RAM, DRAM (dynamic RAM), EDO RAM (extended data out RAM), SRAM (static RAM), etc. One or more of non-volatile memory media 160 and 170 may include nonvolatile storage such as, for example, a read only memory (ROM), a programmable ROM (PROM), an erasable PROM (EPROM), an electrically erasable PROM, NVRAM (non-volatile RAM), ferroelectric RAM (FRAM), a magnetic medium (e.g., a hard drive, a floppy disk, a magnetic tape, etc.), optical storage (e.g., a CD, a DVD, a BLU-RAY disc, etc.), flash memory, a SSD, etc. In one or more embodiments, a memory medium can include one or more volatile storages and/or one or more nonvolatile storages.

In one or more embodiments, network interface 180 may be utilized in communicating with one or more networks and/or one or more other information handling systems. In one example, network interface 180 may enable IHS 110 to communicate via a network utilizing a suitable transmission protocol and/or standard. In a second example, network interface 180 may be coupled to a wired network. In a third example, network interface 180 may be coupled to an optical network. In another example, network interface 180 may be coupled to a wireless network.

In one or more embodiments, network interface 180 may be communicatively coupled via a network to a network storage resource. For example, the network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, an Internet or another appropriate architecture or system that facilitates the communication of signals, data and/or messages (generally referred to as data). For instance, the network may transmit data utilizing a desired storage and/or communication protocol, including one or more of Fibre Channel, Frame Relay, Asynchronous Transfer Mode (ATM), Internet protocol (IP), other packet-based protocol, Internet SCSI (iSCSI), or any combination thereof, among others.

In one or more embodiments, touch controller 185 may receive information from one or more user input devices. In one example, touch controller 185 may receive information from a touch screen. In another example, touch controller 185 may receive information a stylus. In one or more embodiments, touch controller 185 may provide data to processor 120 based at least on the information received from the one or more user input devices. For example, touch controller 185 may provide the data to an operating system executed by processor 120.

In one or more embodiments, communication device 190 may communicate via one or more of IEEE 802.11, WiFi, wireless Ethernet, IEEE 802.15, Bluetooth, Bluetooth Low Energy (BLE), IEEE 802.15.4, ZigBee, Z-Wave, 6LoWPAN, ANT, ANT+, ANT BLAZE, and a proprietary wireless protocol, among others. For example, communication device 190 may communicate information with a stylus, or another one or more peripheral devices, in a wired fashion. In another example, communication device 190 may communicate information with the stylus, or the other one or more peripheral devices, in a wireless fashion. For instance, communication device 280 may communicate the information via an ISM (industrial, scientific, and medical) band.

In one or more embodiments, processor 120 may execute processor instructions in implementing one or more systems, flowcharts, methods, and/or processes described herein. In one example, processor 120 may execute processor instructions from one or more of memory media 150-170 in implementing one or more systems, flowcharts, methods, and/or processes described herein. In another example, processor 120 may execute processor instructions via network interface 180 in implementing one or more systems, flowcharts, methods, and/or processes described herein.

In one or more embodiments, processor 120 may include one or more of a system, a device, and an apparatus operable to interpret and/or execute program instructions and/or process data, among others, and may include one or more of a microprocessor, a microcontroller, a digital signal processor (DSP), an application specific integrated circuit (ASIC), and another digital or analog circuitry configured to interpret and/or execute program instructions and/or process data, among others. In one example, processor 120 may interpret and/or execute program instructions and/or process data stored locally (e.g., via memory media 150-170 and/or another component of IHS 110). In another example, processor 120 may interpret and/or execute program instructions and/or process data stored remotely (e.g., via a network storage resource).

In one or more embodiments, I/O subsystem 175 may represent a variety of communication interfaces, graphics interfaces, video interfaces, user input interfaces, and/or peripheral interfaces, among others. For example, I/O subsystem 175 may include one or more of a touch panel and a display adapter, among others. For instance, a touch panel may include circuitry that enables touch functionality in conjunction with a display that is driven by a display adapter.

As shown, non-volatile memory medium 160 may include an operating system (OS) 162, and applications (APPs) 164-168. In one or more embodiments, one or more of OS 162 and APPs 164-168 may include processor instructions executable by processor 120. In one example, processor 120 may execute processor instructions of one or more of OS 162 and APPs 164-168 via non-volatile memory medium 160. In another example, one or more portions of the processor instructions of the one or more of OS 162 and APPs 164-168 may be transferred to volatile memory medium 150, and processor 120 may execute the one or more portions of the processor instructions of the one or more of OS 162 and APPs 164-168 via volatile memory medium 150.

As illustrated, non-volatile memory medium 170 may include information handling system firmware (IHSFW) 172. In one or more embodiments, IHSFW 172 may include processor instructions executable by processor 120. For example, IHSFW 172 may include one or more structures and/or functionalities of one or more of a basic input/output system (BIOS), an Extensible Firmware Interface (EFI), a Unified Extensible Firmware Interface (UEFI), and an Advanced Configuration and Power Interface (ACPI), among others. In one instance, processor 120 may execute processor instructions of IHSFW 172 via non-volatile memory medium 170. In another instance, one or more portions of the processor instructions of IHSFW 172 may be transferred to volatile memory medium 150, and processor 120 may execute the one or more portions of the processor instructions of IHSFW 172 via volatile memory medium 150.

In one or more embodiments, processor 120 and one or more components of IHS 110 may be included in a system-on-chip (SoC). For example, the SoC may include processor 120 and a platform controller hub (not specifically illustrated).

Turning now to FIGS. 1B and 1C, examples of displays and an example of an information handling system are illustrated, according to one or more embodiments. As shown in FIG. 1B, one or more of displays 195A-195C may be coupled to IHS 110. As illustrated in FIG. 1C, IHS 110 may include one or more of displays 195A-195C. In one or more embodiments, display 195 may display information to one or more of a user and a camera, among others. In one or more embodiments, display 195 may be or include a touch screen. In one example, the touch screen may be or include a resistive touch screen. In another example, the touch screen may be or include a capacitive sensing touch screen. Although not specifically illustrated, display 195 may be communicatively coupled to processor 120, according to one or more embodiments. For example, display 195 may be communicatively coupled to processor 120 via one or more of a display adapter, a video controller, and a graphics processing unit, among others.

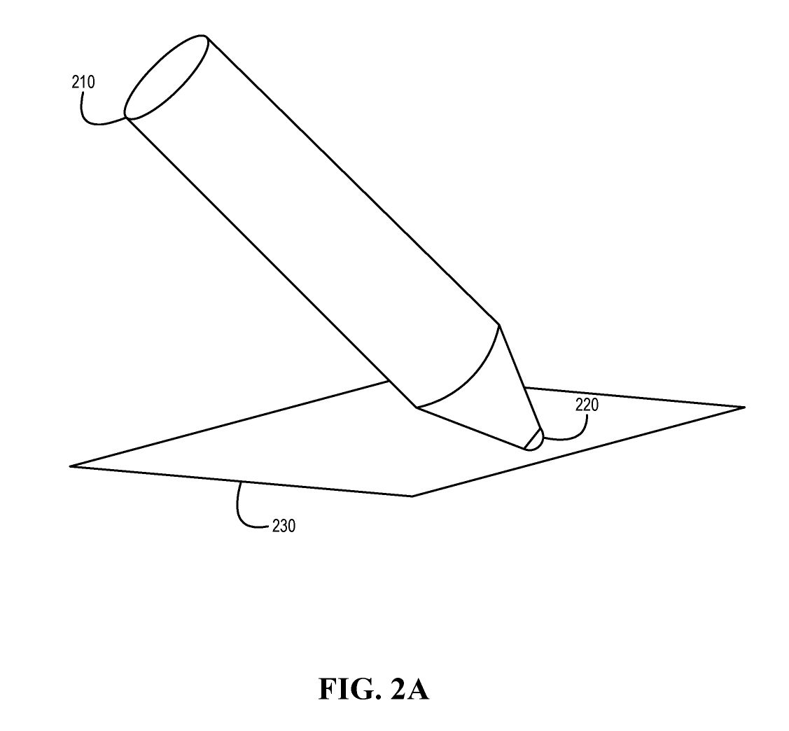

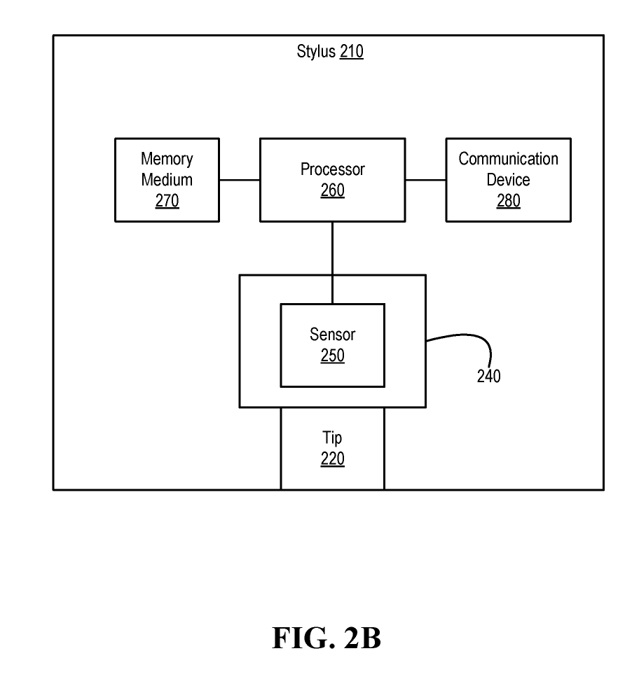

Turning now to FIGS. 2A and 2B, an example stylus is illustrated, according to one or more embodiments. As shown in FIG. 2A, a stylus 210 may include a tip 220. In one or more embodiments, tip 220 may or may not be in contact with a surface 230. In one example, a user may not have tip 220 in contact with surface 230. In another example, the user may have tip 220 in contact with surface 230. In one or more embodiments, surface 230 may be or include any suitable surface. In one example, surface 230 may be or include a flat surface. In a second example, surface 230 may be or include a display (e.g., display 195). In another example, surface 230 may be or include a non-flat surface. For instance, surface 230 may include one or more depressions and/or one or more rises.

As illustrated in FIG. 2B, stylus 210 may include a pressure sensing device 240. In one or more embodiments, pressure sensing device 240 may determine a force of pressure of tip 220 in contact with surface 230. For example, pressure sensing device 240 may include one or more of an elastomer material and a spring, among others. In one instance, pressure sensing device 240 may determine a force of pressure of tip 220 in contact with surface 230 via a compression of the one or more of the elastomer material and the spring. In another instance, pressure sensing device 240 may determine a force of pressure of tip 220 in contact with surface 230 via an elongation of the one or more of the elastomer material and the spring. In one or more embodiments, pressure sensing device 240 may be referred to as a force sensing device.

In one or more embodiments, pressure sensing device 240 may provide one or more output signals that indicate one or more forces of pressure of tip 220 in contact with surface 230. In one example, pressure sensing device 240 may provide one or more output digital signals that indicate the one or more forces of pressure. In another example, pressure sensing device 240 may provide one or more output analog signals that indicate the one or more forces of pressure. For instance, the one or more output analog signals may be or include one or more voltages.

As shown, pressure sensing device 240 may include a sensor 250. In one or more embodiments, sensor 250 may determine a force of tip 220 in contact with surface 230. For example, sensor 250 may be or include one or more microelectromechanical systems (MEMS) that may determine a force of tip 220 in contact with surface 230. In one or more embodiments, sensor 250 may include a strain gauge. For example, the strain gauge may output one or more voltages. For instance, the one or more voltages may be associated with one or more compressions and/or one or more elongations of the strain gauge. In one or more embodiments, a voltage from the strain gauge may be converted into digital data. For example, an analog to digital conversion (ADC) system, method, and/or process may convert an analog voltage from the strain gauge into digital data. In one instance, pressure sensing device 240 may include ADC circuitry that may convert one or more analog signals into digital data. In another instance, a processor 260 may include ADC circuitry that may convert one or more analog signals into digital data.

As illustrated, stylus 210 may include processor 260, memory medium 270, and communication device 280. As shown, pressure sensing device 240, memory medium 270, and communication device 280 may be coupled to processor 260. In one or more embodiments, processor 260 may execute processor instructions in implementing one or more systems, flowcharts, methods, and/or processes described herein. In one example, processor 260 may execute processor instructions from memory medium 270 in implementing one or more systems, flowcharts, methods, and/or processes described herein. For instance, memory medium 270 may include the processor instructions. In another example, processor 260 may execute processor instructions via communication device 280 in implementing one or more systems, flowcharts, methods, and/or processes described herein. For instance, communication device 280 may receive processor instructions and provide the processor instructions to one or more of processor 260 and memory medium 270.

In one or more embodiments, communication device 280 may communicate, with IHS 110, information associated with one or more forces of pressure of tip 220 in contact with surface 230. In one example, communication device 280 may communicate the information to IHS 110 in a wired fashion. In another example, communication device 280 may communicate the information to IHS 110 in a wireless fashion. For instance, communication device 280 may communicate the information to IHS 110 via an ISM (industrial, scientific, and medical) band. In one or more embodiments, communication device 280 may communicate via one or more of IEEE 802.11, WiFi, wireless Ethernet, IEEE 802.15, Bluetooth, BLE, IEEE 802.15.4, ZigBee, Z-Wave, 6LoWPAN, ANT, ANT+, ANT BLAZE, and a proprietary wireless protocol, among others.

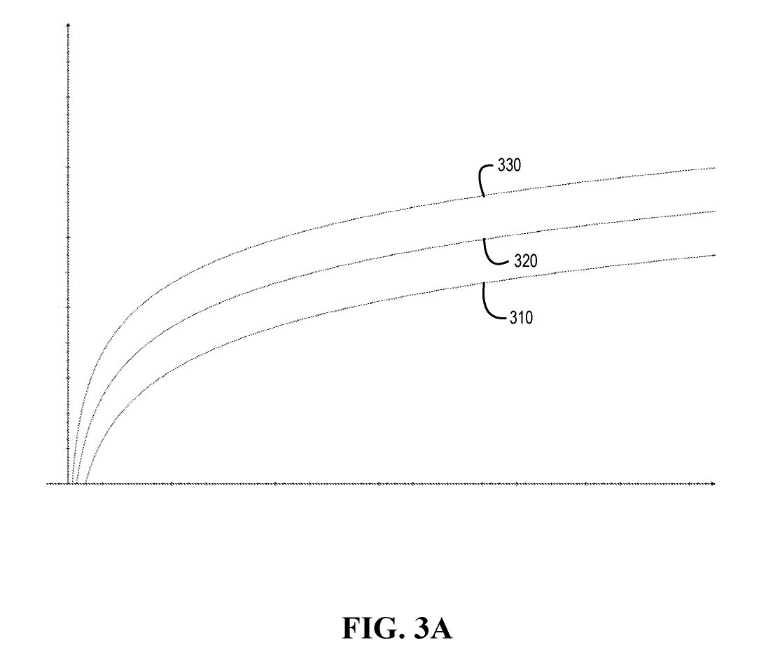

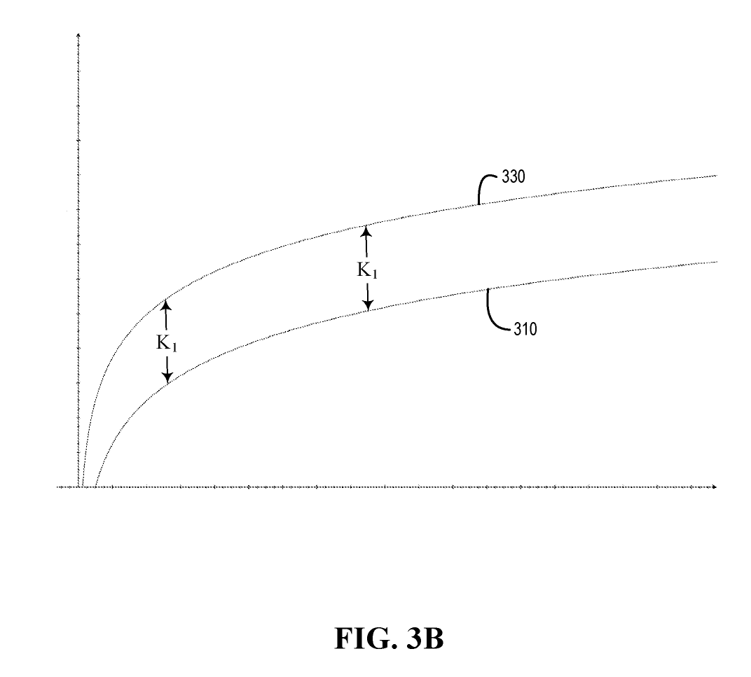

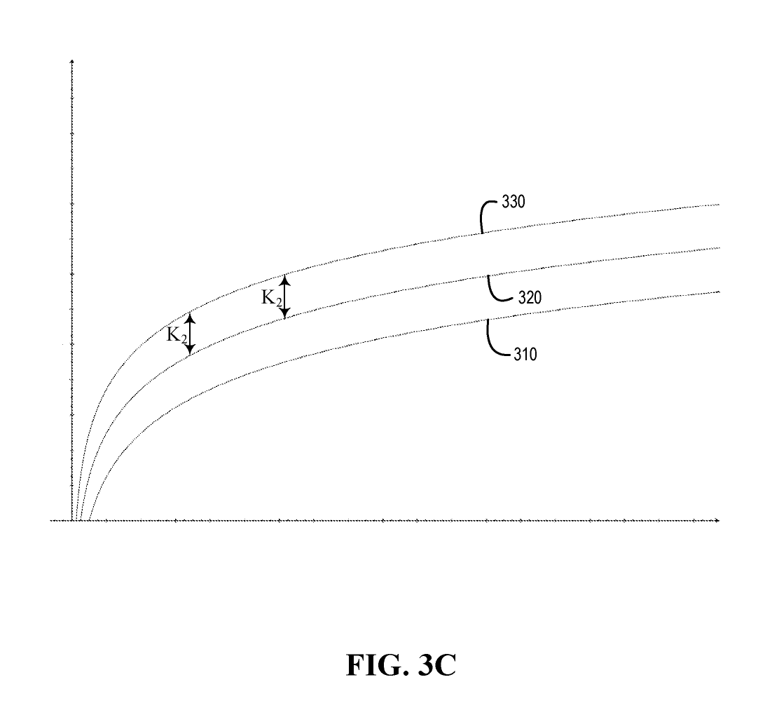

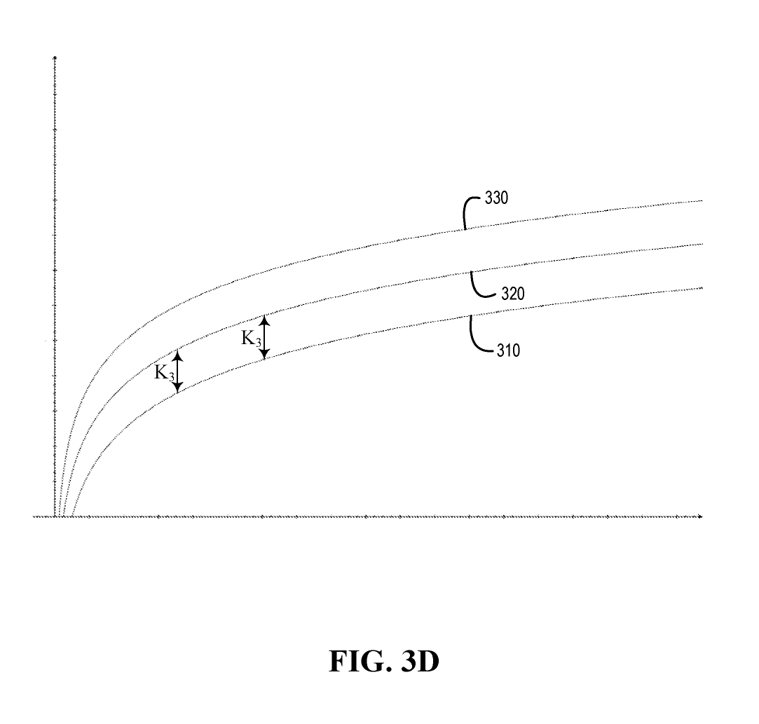

Turning now to FIG. 3A, examples of response curves are illustrated, according to one or more embodiments. As shown, three example response curves 310-330 are shown. In one example, response curve 310 may be associated with a first mode of utilization of stylus 210. In a second example, response curve 320 may be associated with a second mode of utilization of stylus 210. In another example, response curve 330 may be associated with a third mode of utilization of stylus 210. As illustrated, response curves 310-330 may be based at least on a logarithmic function. For example, the horizontal axis of FIG. 3 may be associated with input pressures, and the vertical axis of FIG. 3 may be associated with responses based at least on the input pressures. For instance, the pressures on the horizontal axis may be scaled in accordance with one or more embodiments and/or one or more implementations. In one example, response curve 310 may be associated with f_{R}(x)=71.723·Ln(x)−115.43. In a second example, response curve 320 may be associated with f_{R}(x)=71.723·Ln(x)−165.15. In another example, response curve 330 may be associated with f_{R}(x)=71.723·Ln(x)−214.86. Other response curves associated with other modes of utilization of stylus 210 may be utilized, according to one or more embodiments. In one or more embodiments, a response curve may be associated with a type of stylus utilization. In one example, response curve 310 may be suitable for graphical user interface operations. In a second example, response curve 320 may be suitable for note-taking. In another example, response curve 330 may be suitable for artistic work.

In one or more embodiments, one or more of stylus 210 and touch controller 185 may be configured with an activation force. In one example, one or more of stylus 210 and touch controller 185 may be configured with a first activation force associated with graphical user interface operations. In a second example, one or more of stylus 210 and touch controller 185 may be configured with a second activation force associated with note-taking. For instance, the second activation force may be less than the first activation force. In another example, one or more of stylus 210 and touch controller 185 may be configured with a third activation force associated with artistic work. For instance, the third activation force may be less than the second activation force.

In one or more embodiments, if an activation force is met, one or more of stylus 210 and touch controller 185 may provide output. For example, if an activation force is met, one or more of stylus 210 and touch controller 185 may provide output associated with f_{R}(x)−K, where K is a constant. If f_{R}(x)−K is less than zero (0), no output may be provided or output indicating zero (0) force may be provided as output. In one or more embodiments, the constant K may be selected based on a stylus mode. In one example, the constant K may be selected based on a note-taking mode. For instance, K may be (−115.43−(−165.15)), which would permit, enable, and/or allow stylus 210 to function in the note-taking mode. In a second example, the constant K may be selected based on a graphical user interface operations mode. In one instance, K may be (−115.43−(−214.86)), which would permit, enable, and/or allow stylus 210 to function in the graphical user interface operations mode. In another instance, K may be (−165.15−(−214.86)), which would permit, enable, and/or allow stylus 210 to function in the graphical user interface operations mode.

As shown in FIG. 3B, the constant K₁ may be utilized to adjust response curve 330 to response curve 310. For example, K₁ may be (−115.43−(−214.86)), which would permit, enable, and/or allow stylus 210 to function in the graphical user interface operations mode. For instance, adjusting response curve 330 to response curve 310 may include subtracting K₁ from response curve 330. As illustrated in FIG. 3C, the constant K₂ may be utilized to adjust response curve 330 to response curve 320. For example, (−115.43−(−165.15)), which would permit, enable, and/or allow stylus 210 to function in the note-taking mode. For instance, adjusting response curve 330 to response curve 320 may include subtracting K₂ from response curve 330. As shown in FIG. 3D, the constant K₃ may be utilized to adjust response curve 320 to response curve 310. For example, K₃ may be (−165.15−(−214.86)), which would permit, enable, and/or allow stylus 210 to function in the graphical user interface operations mode. For instance, adjusting response curve 320 to response curve 310 may include subtracting K₃ from response curve 320. In one or more embodiments, two or more of K₁, K₂, and K₃ may be equal. In one or more embodiments, two or more of K₁, K₂, and K₃ may be different.

In one or more embodiments, adjusting a response curve by a constant K may permit, allow, enable, and/or configure stylus 210 to function via multiple modes. In one example, if stylus 210 supports the artistic work mode and a graphical user interface mode is desired, one or more of stylus 210 and touch controller may be configured with an activation pressure associated with the graphical user interface mode and a constant K₁ (e.g., shown in FIG. 3B), which would permit, enable, and/or allow stylus 210 to function in the graphical user interface mode. In a second example, if stylus 210 supports the artistic work mode and a note-taking mode is desired, one or more of stylus 210 and touch controller may be configured with an activation pressure associated with the note-taking mode and a constant K₂ (e.g., shown in FIG. 3C), which would permit, enable, and/or allow stylus 210 to function in the note-taking mode. In another example, if stylus 210 supports the note-taking mode and a graphical user interface mode is desired, one or more of stylus 210 and touch controller may be configured with an activation pressure associated with the graphical user interface mode and a constant K₃ (e.g., shown in FIG. 3D), which would permit, enable, and/or allow stylus 210 to function in the graphical user interface mode.

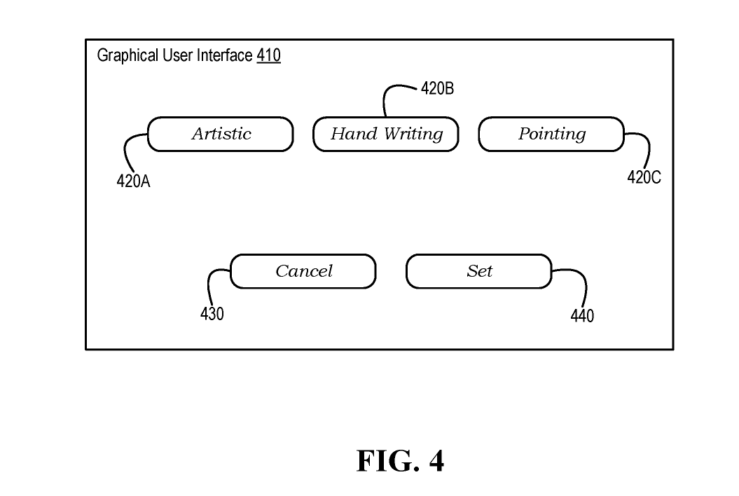

Turning now to FIG. 4, an example graphical user interface is illustrated, according to one or more embodiments. As shown, a graphical user interface (GUI) 410 may include one or more selection icons/buttons 420A-420C, 430, and 440. In one or more embodiments, a selection icon/button 420 may be selected by a user to select an input mode associated with stylus 210. In one example, selection icon/button 420A may be selected by the user to select an artistic input mode. For instance, receiving user input via selection icon/button 420A may indicate that response curve 310 may be utilized. In a second example, selection icon/button 420B may be selected by the user to select a hand writing (e.g., note-taking) input mode. For instance, receiving user input via selection icon/button 420B may indicate that response curve 320 may be utilized. In another example, selection icon/button 420C may be selected by the user to select a pointing input mode. For instance, receiving user input via selection icon/button 420C may indicate that response curve 330 may be utilized. In one or more embodiments, cancel selection icon/button 430 may be selected by the user to cancel a selection and/or set selection icon/button 440 may be selected by the user to set a selection.

In one or more embodiments, GUI 410 may be associated with an application. For example, GUI 410 may be associated with an application of APPs 164-168. For instance, GUI 410 may be utilized by the application to set a stylus mode of utilization with the application. In one or more embodiments, GUI 410 may be associated with an OS. For example, GUI 410 may be associated with OS 162. For instance, GUI 410 may be utilized by OS 162 to set a stylus mode of utilization.

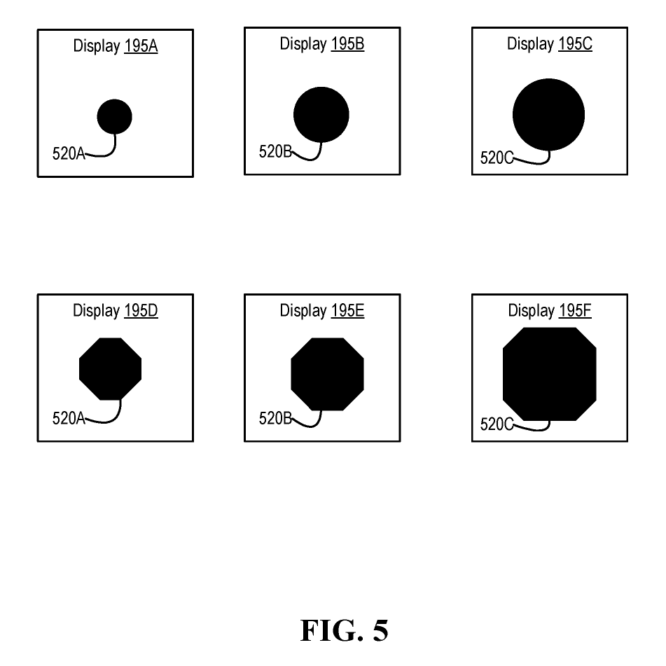

Turning now to FIG. 5, examples of digital markings are illustrated, according to one or more embodiments. In one or more embodiments, a display 195 may show digital markings to a user and/or a camera. For example, the digital markings may be associated with one or more activation pressures. For instance, the digital markings may be associated with one or more stylus utilization modes.

As illustrated, display 195 may show a digital marking 520. In one or more embodiments, display 195 may show a digital marking 520 (e.g., digital inking), via a number of pixels of a display (e.g., display 195), in response to stylus 210 contacting surface 230. In one example, display 195A may show digital marking 520A in response to stylus 210 contacting surface 230, when a first stylus utilization mode is utilized. For instance, the first stylus utilization mode may be or include an artistic mode and/or correspond to response curve 310. In a second example, display 195B may show digital marking 520B in response to stylus 210 contacting surface 230, when a second stylus utilization mode is utilized. For instance, the second stylus utilization mode may be or include a hand writing (e.g., note-taking) mode and/or correspond to response curve 320. In a second example, display 195C may show digital marking 520C in response to stylus 210 contacting surface 230, when a third stylus utilization mode is utilized. For instance, the third stylus utilization mode may be or include a pointing mode and/or correspond to response curve 330.

In one or more embodiments, digital marking 520 may include an activation of one or more pixels and/or a deactivation of one or more other pixels. In one example, the activation of the one or more pixels and/or the deactivation of the one or more other pixels may produce one or more shapes. In one instance, the activation of the one or more pixels and/or the deactivation of the one or more other pixels may produce one or more shapes as shown in display 195A-195C. In another instance, the activation of the one or more pixels and/or the deactivation of the one or more other pixels may produce one or more shapes as shown in display 195E-195F.

In one or more embodiments, digital marking 520 may be associated with a diameter. In one example, digital marking 520A may be associated with a first diameter. In a second example, digital marking 520B may be associated with a second diameter. For instance, the second diameter may be greater than the first diameter. In a third example, digital marking 520C may be associated with a third diameter. For instance, the third diameter may be greater than the second diameter. In another example, other greater diameters and/or other smaller diameters may be utilized with digital marking 520. In one or more embodiments, a user may apply an additional force of pressure of tip 220 in contact with surface 230. For example, additional marking digital marking 520 may be displayed in response to the additional force. For instance, a greater diameter of digital marking 520 may be displayed in response to the additional force.

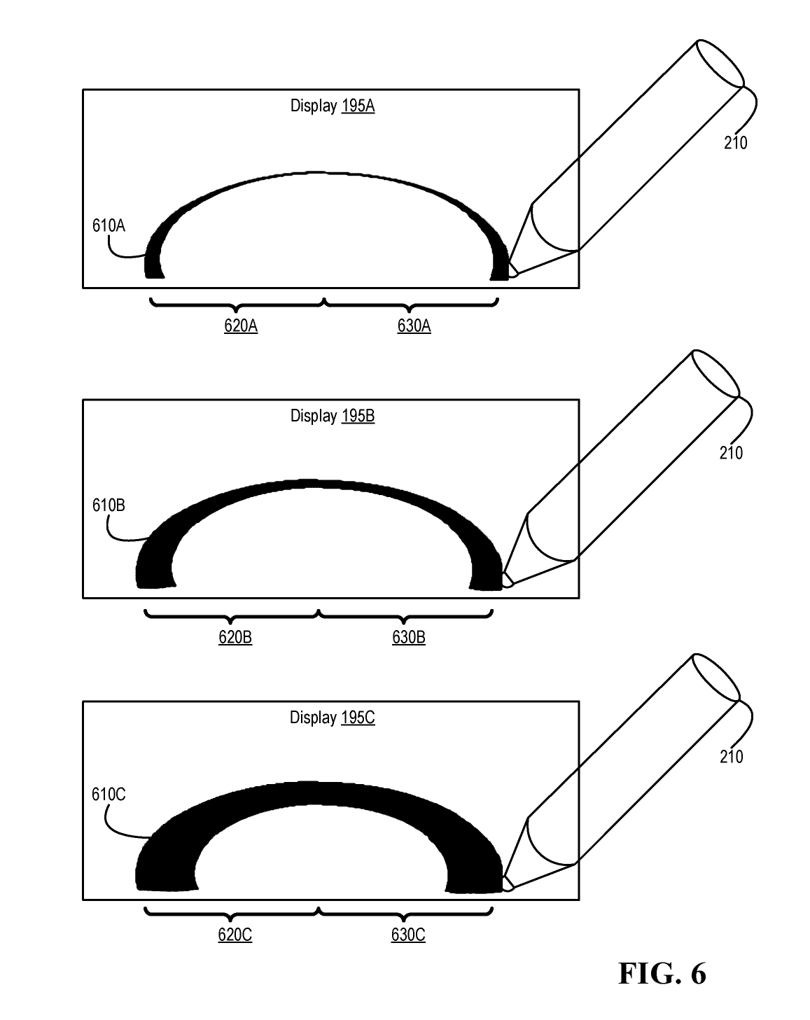

Turning now to FIG. 6, other examples of digital markings are illustrated, according to one or more embodiments. In one or more embodiments, display 195 may show digital markings to a user and/or a camera, among others. For example, the digital markings may be associated with one or more activation pressures. For instance, the digital markings may be associated with one or more stylus utilization modes. In one or more embodiments, display 195 may be associated with surface 230. In one example, display 195 may include surface 230. In another example, surface 230 may be located on display 195.

As illustrated, display 195A may show a digital marking 610A. In one or more embodiments, display 195A may show a digital marking 610A (e.g., digital inking) in response to stylus 210 contacting display 195A. In one example, display 195A may show digital marking 610A in response to stylus 210 contacting display 195A, when a first stylus utilization mode is utilized. For instance, the first stylus utilization mode may be or include an artistic mode and/or correspond to response curve 310. In a second example, display 195B may show digital marking 610B in response to stylus 210 contacting display 195B, when a second stylus utilization mode is utilized. For instance, the second stylus utilization mode may be or include a hand writing (e.g., note-taking) mode and/or correspond to response curve 320. In another example, display 195C may show digital marking 610C in response to stylus 210 contacting display 195C, when a third stylus utilization mode is utilized. For instance, the third stylus utilization mode may be or include a pointing mode and/or correspond to response curve 330.

In one or more embodiments, digital marking 610 may include an activation of one or more pixels and/or a deactivation of one or more other pixels. For example, same stylus pressures may be utilized for digital markings 610A-610C corresponding to response curves 310-330, respectively. In one instance, moving from left to right through a section 620A, stylus pressure may decrease. In a second instance, moving from left to right through a section 630A, stylus pressure may increase. In a third instance, moving from left to right through a section 620B, stylus pressure may decrease. In a fourth instance, moving from left to right through a section 630B, stylus pressure may increase. In a fifth instance, moving from left to right through a section 620B, stylus pressure may decrease. In another instance, moving from left to right through a section 630B, stylus pressure may increase. In one or more embodiments, pressures may be the same across each of sections 320A-320C. In one or more embodiments, pressures may be the same across each of sections 330A-330C.

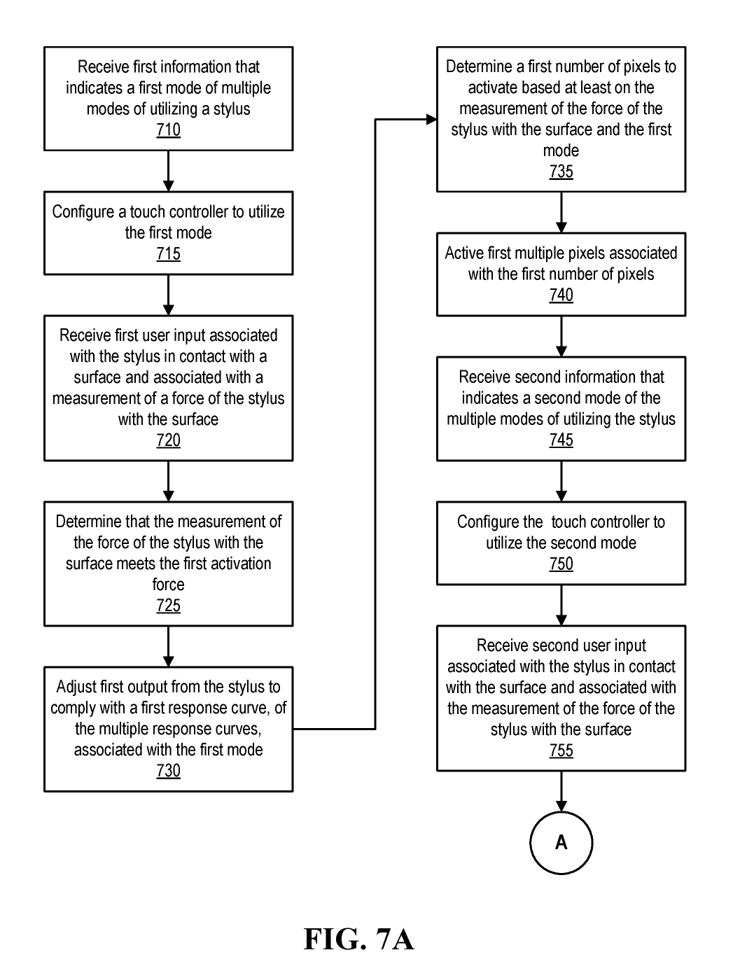

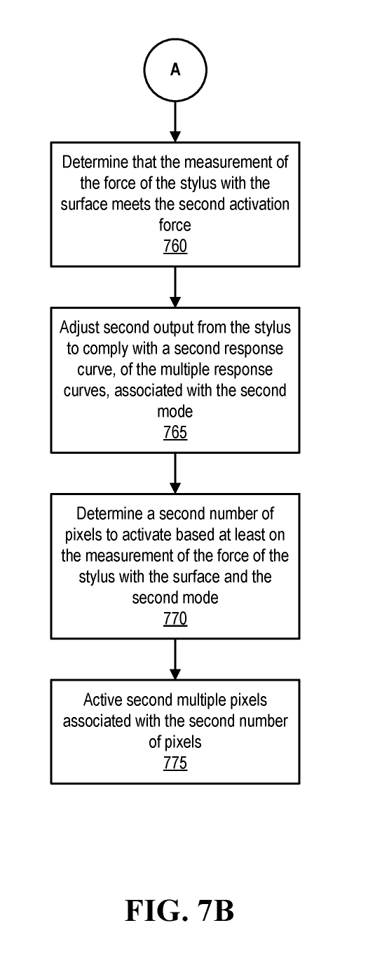

Turning now to FIGS. 7A and 7B, an example of a method of utilizing an information handling system is illustrated, according to one or more embodiments. At 710, first information that indicates a first mode of multiple modes of utilizing a stylus, associated with multiple response curves, may be received. For example, at least one of an application, the stylus, a setup utility (e.g., a setup utility of an operating system (e.g., OS 162)), and a graphical user interface (e.g., GUI 410), among others, may receive the first information that indicates the first mode of the multiple modes of utilizing the stylus. In one or more embodiments, the multiple modes of utilizing the stylus may be associated with respective multiple response curves. For example, the multiple modes of utilizing the stylus may be associated with response curves 310-330, among others.

At 715, a touch controller may be configured to utilize the first mode that is associated with a first activation force. For example, touch controller 185 may be configured to utilize the first mode and the first activation force. In one instance, IHS 110 may configure touch controller 185 to utilize the first mode and the first activation force. In another instance, one or more an application, a setup utility (e.g., a setup utility of an operating system (e.g., OS 162)), and a graphical user interface (e.g., GUI 410), among others, may configure touch controller 185 to utilize the first mode and the first activation force.

At 720, first user input associated with the stylus in contact with a surface and associated with a measurement of a force of the stylus with the surface may be received. In one example, IHS 110 may receive the first user input associated with stylus 210 in contact with surface 230 and associated with a measurement of a force of stylus 210 with surface 230. In another example, one or more an application, an operating system (e.g., OS 162), and a graphical user interface, among others, may receive the first user input associated with stylus 210 in contact with surface 230 and associated with a measurement of a force of stylus 210 with surface 230. In one or more embodiments, the measurement of the force of stylus 210 with surface 230 may be a number. For example, the number may be generated from an ADC system, process, and/or method of stylus 210. In one or more embodiments, IHS 110 may wirelessly receive the measurement of the force of stylus 210 with surface 230. For example, IHS 110 may wirelessly receive, from stylus 210, a number that represents the measurement of the force of stylus 210 with surface 230.

At 725, it may be determined that the measurement of the force of the stylus with the surface meets the first activation force. In one example, IHS 110 may determine that the measurement of the force of stylus 210 with surface 230 meets the first activation force. In another example, touch controller 185 may determine that the measurement of the force of stylus 210 with surface 230 meets the first activation force. In one or more embodiments, determining that the measurement of the force of the stylus with the surface meets the first activation force may include determining that the measurement of the force of the stylus with the surface exceeds the first activation force. In one or more embodiments, if it is determined that the measurement of the force of the stylus with the surface does not meet the first activation force, the method may end or proceed to 720, where additional user input may be received.

At 730, first output from the stylus may be adjusted to comply with a first response curve, of the multiple response curves, associated with the first mode. For example, first output from the stylus may be adjusted by a first constant to comply with a first response curve associated with the first mode. In one instance, IHS 110 may adjust the first output from stylus 210 by the first constant to comply with the first response curve associated with the first mode. In another instance, touch controller may adjust the first output from stylus 210 by the first constant to comply with the first response curve associated with the first mode. In one or more embodiments, adjusting the first output from the stylus by a first constant may include subtracting the first constant from the first output.

At 735, a first number of pixels to be activated may be determined based at least on the measurement of the force of the stylus with the surface and the first mode. For example, IHS 110 may determine a first number of pixels to be activated based at least on the measurement of the force of the stylus with the surface and the first mode. At 740, first multiple pixels associated with the first number of pixels may be activated. For example, first multiple pixels, of display 195, associated with the first number of pixels may be activated. In one or more embodiments, activating the first multiple pixels may be or include a first digital inking.

At 745, second information that indicates a second mode of multiple modes of utilizing the stylus may be received. For example, at least one of an application, the stylus, a setup utility (e.g., a setup utility of an operating system (e.g., OS 162)), and a graphical user interface (e.g., GUI 410), among others, may receive the second information that indicates the second mode of the multiple modes of utilizing the stylus. At 750, the touch controller may be configured to utilize the second mode that is associated with a second activation force. For example, touch controller 185 may be configured to utilize the second mode and the second activation force. In one instance, IHS 110 may configure touch controller 185 to utilize the second mode and the second activation force. In another instance, one or more an application, a setup utility (e.g., a setup utility of an operating system (e.g., OS 162)), and a graphical user interface (e.g., GUI 410), among others, may configure touch controller 185 to utilize the second mode and the second activation force.

At 755, second user input, different from the first user input, associated with the stylus in contact with the surface and associated with the measurement of the force of the stylus with the surface may be received. In one or more embodiments, the measurement of the force of the stylus with the surface associated with the second user input may be the measurement of the force of the stylus with the surface associated with the first user input. In one example, IHS 110 may receive the second user input associated with stylus 210 in contact with surface 230 and associated with the measurement of the force of stylus 210 with surface 230. In another example, one or more an application, an operating system (e.g., OS 162), and a graphical user interface, among others, may receive the second user input associated with stylus 210 in contact with surface 230 and associated with a measurement of a force of stylus 210 with surface 230. In one or more embodiments, IHS 110 may wirelessly receive the measurement of the force of stylus 210 with surface 230. For example, IHS 110 may wirelessly receive, from stylus 210, a number that represents the measurement of the force of stylus 210 with surface 230.

At 760, it may be determined that the measurement of the force of the stylus with the surface meets the second activation force. In one example, IHS 110 may determine that the measurement of the force of stylus 210 with surface 230 meets the second activation force. In another example, touch controller 185 may determine that the measurement of the force of stylus 210 with surface 230 meets the second activation force. In one or more embodiments, determining that the measurement of the force of the stylus with the surface meets the second activation force may include determining that the measurement of the force of the stylus with the surface exceeds the second activation force. In one or more embodiments, if it is determined that the measurement of the force of the stylus with the surface does not meet the second activation force, the method may end or proceed to 755, where additional user input may be received.

At 765, second output from the stylus may be adjusted to comply with a second response curve, of the multiple response curves, associated with the second mode. For example, second output from the stylus may be adjusted by a second constant to comply with a second response curve associated with the second mode. In one instance, IHS 110 may adjust the second output from stylus 210 by the second constant to comply with the second response curve associated with the second mode. In another instance, touch controller may adjust the second output from stylus 210 by the second constant to comply with the second response curve associated with the second mode. In one or more embodiments, adjusting the second output from the stylus by a second constant may include subtracting the second constant from the second output. In one or more embodiments, the second constant may be equal to the first constant. In one or more embodiments, the second constant may be different than the first constant.

At 770, a second number of pixels, different from the first number of pixels to be activated may be determined based at least on the measurement of the force of the stylus with the surface and the second mode. For example, IHS 110 may determine a second number of pixels to be activated based at least on the measurement of the force of the stylus with the surface and the second mode. In one or more embodiments, the second number of pixels may be greater than the first number of pixels. In one or more embodiments, the second number of pixels may be less than the first number of pixels. At 775, second multiple pixels associated with the second number of pixels may be activated. For example, second multiple pixels, of display 195, associated with the second number of pixels may be activated. In one or more embodiments, activating the second multiple pixels may be or include a second digital inking.

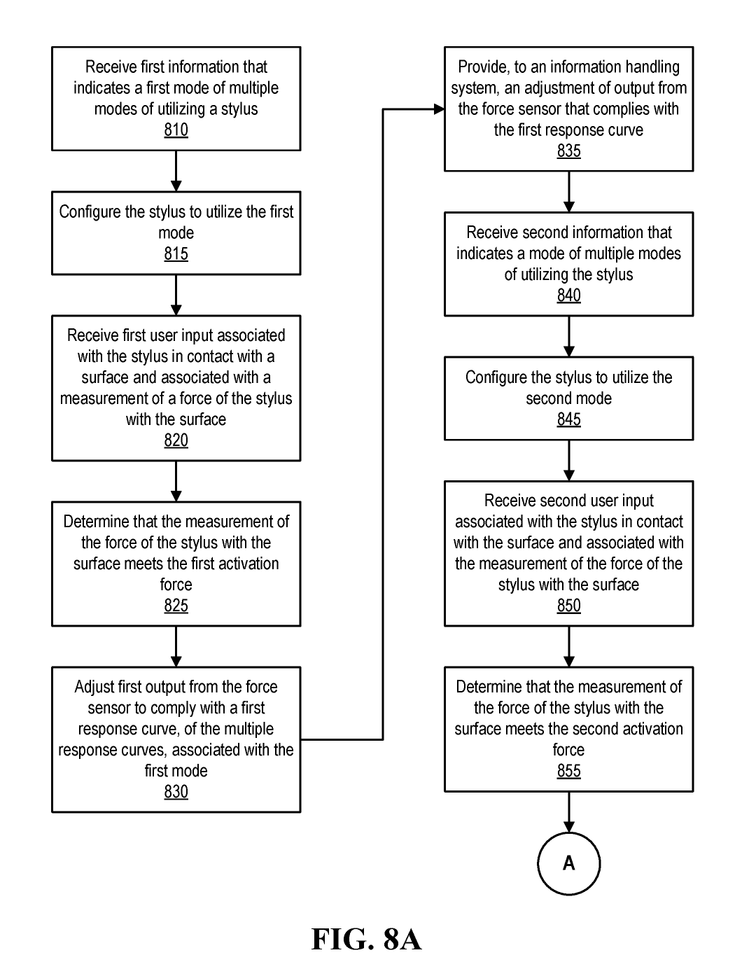

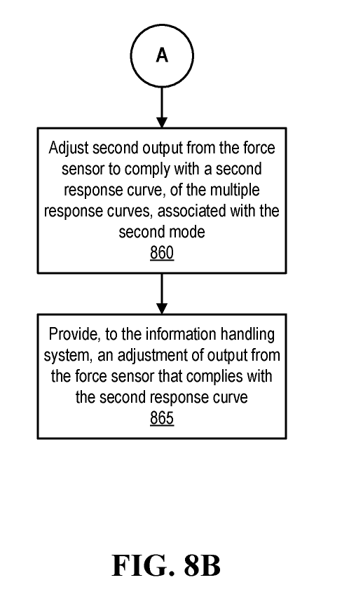

Turning now to FIGS. 8A and 8B, an example of a method of operating a stylus is illustrated, according to one or more embodiments. At 810, first information that indicates a first mode of multiple modes of utilizing a stylus that are associated with multiple response curves may be received. For example, stylus 210 may wirelessly receive, from IHS 110, first information that indicates a first mode of multiple modes of utilizing a stylus that are associated with multiple response curves. For instance, stylus 210 may wirelessly receive, from IHS 110, the first information that indicates the first mode from at least one of an application, a graphical user interface, and a setup utility of an operating system that executes on IHS 110.

At 815, the stylus may be configured to utilize the first mode that is associated with a first activation force. For example, stylus 210 may wirelessly receive first configuration information from IHS 110. For instance, processor 260 may utilize the first configuration information to configure stylus 210 to utilize the first mode that is associated with the first activation force. In one or more embodiments, stylus 210 may wirelessly receive the first configuration information from at least one of an application, a graphical user interface, and a setup utility of an operating system that executes on IHS 110.

At 820, first user input associated with the stylus in contact with a surface and associated with a measurement of a force of the stylus with the surface may be received. For example, processor 260 may receive the first user input associated with stylus 210 in contact with surface 230 and associated with a measurement of a force of stylus 210 with surface 230. In one or more embodiments, the measurement of the force of stylus 210 with surface 230 may be a number. For example, the number may be generated from an ADC system, process, and/or method of stylus 210. In one or more embodiments, stylus 210 may include a force sensor that is coupled to processor 260 and that is configured to measure forces of the stylus in contact with the surface. For example, the ADC system, process, and/or method of stylus 210 may transform analog signals from the force sensor into digital data. For instance, processor 260 may receive the digital data from the ADC system, process, and/or method.

At 825, it may be determined that the measurement of the force of the stylus with the surface meets the first activation force. For example, processor 260 may determine that the measurement of the force of stylus 210 with surface 230 meets the first activation force. In one or more embodiments, determining that the measurement of the force of the stylus with the surface meets the first activation force may include determining that the measurement of the force of the stylus with the surface exceeds the first activation force. In one or more embodiments, if it is determined that the measurement of the force of the stylus with the surface does not meet the first activation force, the method may end or proceed to 820, where additional user input may be received.

At 830, first output from the force sensor may be adjusted to comply with a first response curve, of the multiple response curves, associated with the first mode. For example, first output from the force sensor may be adjusted by a first constant to comply with a first response curve associated with the first mode. For instance, processor 260 may adjust the first output from the force sensor by the first constant to comply with the first response curve associated with the first mode. In one or more embodiments, adjusting the first output from the stylus by a first constant may include subtracting the first constant from the first output. At 835, the stylus may provide, to the information handling system, an adjustment of the first output from the force sensor that complies with the first response curve. For example, stylus 210 may wirelessly provide, to IHS 110, an adjustment of the first output from the force sensor that complies with the first response curve. For instance, stylus 210 may wirelessly provide, to IHS 110, the adjustment of the first output from the force sensor that complies with the first response curve via communication device 280.

At 840, second information that indicates a second mode of the multiple modes of utilizing a stylus that are associated with the multiple response curves may be received. For example, stylus 210 may wirelessly receive, from IHS 110, first information that indicates a second mode of the multiple modes of utilizing a stylus that are associated with the multiple response curves. For instance, stylus 210 may wirelessly receive, from IHS 110, the second information that indicates the second mode from at least one of an application, a graphical user interface, and a setup utility of an operating system that executes on IHS 110.

At 845, the stylus may be configured to utilize the second mode that is associated with a second activation force. For example, stylus 210 may wirelessly receive second configuration information from IHS 110. For instance, processor 260 may utilize the second configuration information to configure stylus 210 to utilize the second mode that is associated with the second activation force. In one or more embodiments, stylus 210 may wirelessly receive the second configuration information from at least one of an application, a graphical user interface, and a setup utility of an operating system that executes on IHS 110.

At 850, second user input associated with the stylus in contact with the surface and associated with the measurement of the force of the stylus with the surface may be received. For example, processor 260 may receive the second user input associated with stylus 210 in contact with surface 230 and associated with the measurement of the force of stylus 210 with surface 230. In one or more embodiments, the measurement of the force of stylus 210 with surface 230 may be a number. For example, the number may be generated from an ADC system, process, and/or method of stylus 210. In one or more embodiments, stylus 210 may include a force sensor that is coupled to processor 260 and that is configured to measure forces of the stylus in contact with the surface. For example, the ADC system, process, and/or method of stylus 210 may transform analog signals from the force sensor into digital data. For instance, processor 260 may receive the digital data from the ADC system, process, and/or method.

At 855, it may be determined that the measurement of the force of the stylus with the surface meets the second activation force. For example, processor 260 may determine that the measurement of the force of stylus 210 with surface 230 meets the second activation force. In one or more embodiments, determining that the measurement of the force of the stylus with the surface meets the second activation force may include determining that the measurement of the force of the stylus with the surface exceeds the second activation force. In one or more embodiments, if it is determined that the measurement of the force of the stylus with the surface does not meet the second activation force, the method may end or proceed to 850, where additional user input may be received.

At 860, second output from the force sensor may be adjusted to comply with a second response curve, of the multiple response curves, associated with the second mode. For example, second output from the force sensor may be adjusted by a second constant to comply with a second response curve associated with the second mode. For instance, processor 260 may adjust the second output from the force sensor by the second constant to comply with the second response curve associated with the first mode. In one or more embodiments, adjusting the second output from the stylus by a second constant may include subtracting the second constant from the second output. In one or more embodiments, the second constant may be equal to the first constant. In one or more embodiments, the second constant may be different than the first constant. At 865, the stylus may provide, to the information handling system, an adjustment of the second output from the force sensor that complies with the second response curve. For example, stylus 210 may wirelessly provide, to IHS 110, an adjustment of the second output from the force sensor that complies with the second response curve. For instance, stylus 210 may wirelessly provide, to IHS 110, the adjustment of the second output from the force sensor that complies with the second response curve via communication device 280.

In one or more embodiments, one or more of the method and/or process elements and/or one or more portions of a method and/or processor elements may be performed in varying orders, may be repeated, or may be omitted. Furthermore, additional, supplementary, and/or duplicated method and/or process elements may be implemented, instantiated, and/or performed as desired, according to one or more embodiments. Moreover, one or more of system elements may be omitted and/or additional system elements may be added as desired, according to one or more embodiments.

In one or more embodiments, a memory medium may be and/or may include an article of manufacture. For example, the article of manufacture may include and/or may be a software product and/or a program product. For instance, the memory medium may be coded and/or encoded with processor-executable instructions in accordance with one or more flowcharts, systems, methods, and/or processes described herein to produce the article of manufacture.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An information handling system, comprising:
at least one processor;
a touch controller that is coupled to the at least one processor; and
a memory medium that is coupled to the at least one processor and that includes instructions, which when executed by the at least one processor, cause the information handling system to:
receive first information that indicates a first mode of a plurality of modes of utilizing a stylus that are associated with a plurality of response curves;
configure the touch controller to utilize the first mode that is associated with a first activation force;
receive first user input associated with the stylus in contact with a surface and associated with a measurement of a force of the stylus with the surface;
determine that the measurement of the force of the stylus with the surface meets the first activation force;
adjust first output from the stylus to comply with a first response curve, of the plurality of response curves, associated with the first mode;
determine a first number of pixels to activate based at least on the measurement of the force of the stylus with the surface and an adjustment of the first output from the stylus to comply with the first response curve;
activate a first plurality of pixels associated with the first number of pixels;
receive second information that indicates a second mode of the plurality of modes of utilizing the stylus;
configure the touch controller to utilize the second mode that includes a second activation force;
receive second user input associated with the stylus in contact with the surface and associated with the measurement of the force of the stylus with the surface;
determine that the measurement of the force of the stylus with the surface meets the second activation force;
adjust second output from the stylus to comply with a second response curve, of the plurality of response curves, associated with the second mode;
determine a second number of pixels, different from the first number of pixels, to activate based at least on the measurement of the force of the stylus with the surface and an adjustment of the second output from the stylus to comply with the second response curve; and
activate a second plurality of pixels associated with the second number of pixels.

2. The information handling system of claim 1, wherein, to adjust the first output from the stylus to comply with the first response curve, the instructions further cause the information handling system to adjust the first output from the stylus by a constant.

3. The information handling system of claim 1, wherein, to receive the first user input associated with the stylus in contact with the surface and associated with the measurement of the force of the stylus with the surface, the instructions further cause the information handling system to determine the measurement of the force of the stylus with the surface.

4. The information handling system of claim 3, wherein, to determine the measurement of the force of the stylus with the surface, the instructions further cause the information handling system to wirelessly receive the measurement of the force of the stylus with the surface.

5. The information handling system of claim 1, further comprising:
a display coupled to the at least one processor;
wherein, to activate the first plurality of pixels associated with the first number of pixels, the instructions further cause the information handling system to activate the first plurality of pixels, on the display, associated with the first number of pixels; and
wherein, to activate the second plurality of pixels associated with the second number of pixels, the instructions further cause the information handling system to activate the second plurality of pixels, on the display, associated with the second number of pixels.

6. The information handling system of claim 1, wherein, to receive the first information that indicates the first mode of the plurality of modes of utilizing the stylus, the instructions further cause the information handling system to receive the first information via at least one of an application, the stylus, and a setup utility of an operating system.

7. The information handling system of claim 1, wherein, to receive the first information that indicates the first mode of the plurality of modes of utilizing the stylus, the instructions further cause the information handling system to receive the first information via a user interface.

8. A method of operating an information handling system, comprising:
receiving first information that indicates a first mode of a plurality of modes of utilizing a stylus that are associated with a plurality of response curves;
configuring a touch controller to utilize the first mode that is associated with a first activation force;
receiving first user input associated with the stylus in contact with a surface and associated with a measurement of a force of the stylus with the surface;
determining that the measurement of the force of the stylus with the surface meets the first activation force;
adjusting first output from the stylus to comply with a first response curve, of the plurality of response curves, associated with the first mode;
determining a first number of pixels to activate based at least on the measurement of the force of the stylus with the surface and an adjustment of the first output from the stylus to comply with the first response curve;
activating a first plurality of pixels associated with the first number of pixels;
receiving second information that indicates a second mode of the plurality of modes of utilizing the stylus;
configuring the touch controller to utilize the second mode that includes a second activation force;
receiving second user input associated with the stylus in contact with the surface and associated with the measurement of the force of the stylus with the surface;
determining that the measurement of the force of the stylus with the surface meets the second activation force;
adjusting second output from the stylus to comply with a second response curve, of the plurality of response curves, associated with the second mode;
determining a second number of pixels, different from the first number of pixels, to activate based at least on the measurement of the force of the stylus with the surface and an adjustment of the second output from the stylus to comply with the second response curve; and
activating a second plurality of pixels associated with the second number of pixels.

9. The method of claim 8, wherein the adjusting the first output from the stylus to comply with the first response curve includes adjusting the first output from the stylus by a constant.

10. The method of claim 8, wherein the receiving the first user input associated with the stylus in contact with the surface and associated with the measurement of the force of the stylus with the surface includes determining the measurement of the force of the stylus with the surface.

11. The method of claim 10, wherein the determining the measurement of the force of the stylus with the surface includes wirelessly receiving the measurement of the force of the stylus with the surface.

12. The method of claim 10,
wherein the stylus includes an electronic force sensor; and
wherein the determining the measurement of the force of the stylus with the surface includes the electronic force sensor determining the measurement of the force of the stylus with the surface.

13. The method of claim 8, wherein the receiving the first information that indicates the first mode of the plurality of modes of utilizing the stylus includes at least one of an application receiving the first information, the stylus receiving the first information, and a setup utility of an operating system receiving the first information.

14. The method of claim 8, wherein the receiving the first information that indicates the first mode of the plurality of modes of utilizing the stylus includes receiving the first information via a user interface.

15. A stylus, comprising:
a processor;
a force sensor that is coupled to the processor and that is configured to measure forces of the stylus in contact with a surface; and
a memory medium that is coupled to the processor and that includes instructions, which when executed by the processor, cause the stylus to:
receive first information that indicates a first mode of a plurality of modes of utilizing the stylus that are associated with a plurality of response curves;
configure the stylus to utilize the first mode that is associated with a first activation force;
receive first user input associated with the stylus in contact with the surface and associated with a measurement of a force of the stylus with the surface;
determine that the measurement of the force of the stylus with the surface meets the first activation force;
adjust first output from the force sensor to comply with a first response curve, of the plurality of response curves, associated with the first mode;
provide, to an information handling system, an adjustment of the first output from the force sensor that complies with the first response curve;
receive second information that indicates a second mode of the plurality of modes of utilizing the stylus;
configure the stylus to utilize the second mode that includes a second activation force;
receive second user input associated with the stylus in contact with the surface and associated with the measurement of the force of the stylus with the surface;
determine that the measurement of the force of the stylus with the surface meets the second activation force;
adjust second output from the force sensor to comply with a second response curve, of the plurality of response curves, associated with the second mode; and
provide, to the information handling system, an adjustment of the second output from the force sensor that complies with the second response curve.

16. The stylus of claim 15, wherein, to adjust the first output from the force sensor to comply with the first response curve, the instructions further cause the stylus to adjust the first output from the force sensor by a constant.

17. The stylus of claim 15, wherein, to adjust the first output from the force sensor by a constant, the instructions further cause the stylus to subtract the constant from the first output from the force sensor.

18. The stylus of claim 15, further comprising:
a communication device that is coupled to the processor and that is configured to wirelessly communicate with the information handling system;
wherein, to provide the adjustment of the first output from the force sensor that complies with the first response curve, the instructions further cause the stylus to wirelessly provide, to the information handling system via the communication device, the adjustment of the first output from the force sensor that complies with the first response curve.

19. The stylus of claim 18, wherein, to receive the first information that indicates the first mode, the instructions further cause the stylus to wirelessly receive, via the communication device, the first information that indicates the first mode from at least one of an application, a graphical user interface, and a setup utility of an operating system that executes on the information handling system.

20. The stylus of claim 15, further comprising:
an analog to digital converter that is coupled to the processor, that is coupled to the force sensor, and that is configured to transform analog signals from the force sensor into digital data;
wherein, to determine the measurement of the force of the stylus with the surface via the force sensor, the instructions further cause the stylus to receive the digital data from the analog to digital converter, wherein the digital data include numerical values that represent respective measurements of forces of the stylus with the surface.
